(19) United States
(12) Patent Application Publication
(10) Pub. No.: US 2026/0139645 A1
(43) Pub. Date: May 21, 2026

(54) ENGINE

(71) Applicant: TOYOTA JIDOSHA KABUSHIKI KAISHA, Toyota-shi (JP)

(72) Inventors: Mina KAWAI TACHIBANA, Toyota-shi (JP); Tomihisa TSUCHIYA, Toyota-shi (JP)

(73) Assignee: TOYOTA JIDOSHA KABUSHIKI KAISHA, Toyota-shi (JP)

(21) Appl. No.: 19/302,363

(22) Filed: Aug. 18, 2025

(30) Foreign Application Priority Data
Nov. 15, 2024 (JP) 2024-199635

(51) Int. Cl. F02M 21/02

(52) U.S. Cl. CPC F02M 21/0206

(57) ABSTRACT

In an engine including an injector injecting gaseous fuel into a cylinder, injection timing, an injection quantity, an injection pressure, and an injection angle of the gaseous fuel of the injector, and a nozzle diameter of the injector are set such that a jet of the gaseous fuel injected by the injector does not come into contact with a piston crown surface.

### CROSS-REFERENCE TO RELATED APPLICATION

This application claims priority to Japanese Patent Application No. 2024-199635 filed on Nov. 15, 2024. The disclosure of the above-identified application, including the specification, drawings, and claims, is incorporated by reference herein in its entirety.

### BACKGROUND

### 1. Technical Field

The present disclosure relates to an engine including an injector injecting gaseous fuel into a cylinder.

### 2. Description of Related Art

As an in-cylinder injection engine injecting gaseous fuel, such as hydrogen, into a cylinder, an engine disclosed in Japanese Unexamined Patent Application Publication No. 2024-88239 (JP 2024-88239 A) is known. The publication discloses setting an excess-air ratio to suppress pre-ignition.

### SUMMARY

The excess-air ratio is not a sole factor determining presence or absence of the pre-ignition. Therefore, merely setting the excess-air ratio may not adequately suppress the pre-ignition.

An engine solving the above-described problem is an engine including an injector configured to inject gaseous fuel into a cylinder, in which an injection timing, an injection quantity, an injection pressure, and an injection angle of the gaseous fuel by the injector and a nozzle diameter of the injector are set such that a jet of the gaseous fuel injected by the injector does not come into contact with a piston crown surface.

The engine has an effect of suppressing pre-ignition due to deposits that have detached from the piston crown surface.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration around a cylinder of an engine according to an embodiment; and

FIG. 2 is a diagram showing an injection mode of the gaseous fuel of the engine of FIG. 1.

### DETAILED DESCRIPTION OF EMBODIMENTS

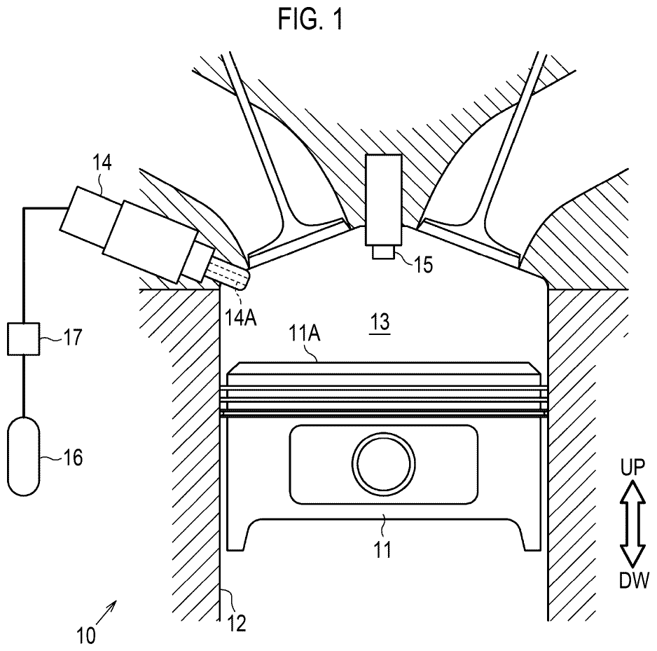

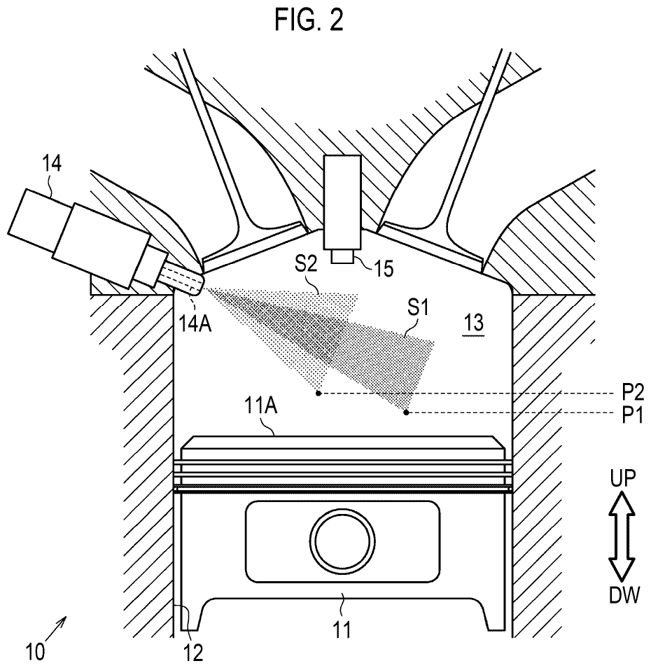

Hereinafter, an embodiment of an engine will be described in detail with reference to FIGS. 1 and 2.

### Configuration of Engine 10

As shown in FIG. 1, the engine 10 of the present embodiment includes a cylinder 12 in which a piston 11 that is reciprocally movable in the vertical direction in the figure is installed. In the following description, the movement direction of the piston 11 in the cylinder 12 is referred to as the cylinder vertical direction. In addition, among the movement directions of the piston 11 in the cylinder 12, a direction toward the bottom dead center is referred to as a lower-region direction DW of the cylinder, and a direction toward the top dead center is referred to as an upper-region direction UP of the cylinder.

The inside of the cylinder 12 is partitioned by the piston 11 to provide a combustion chamber 13 combusting an air-fuel mixture. Around the cylinder 12, an injector 14 injecting hydrogen that is gaseous fuel into the cylinder 12, and an ignition plug 15 igniting an air-fuel mixture by spark discharge are installed. The injector 14 includes an injection port 14A injecting hydrogen. In addition, the injector 14 is connected to the hydrogen tank 16 via a pressure regulator 17. The pressure regulator 17 adjusts the pressure of the hydrogen stored in the hydrogen tank 16 and supplies the hydrogen to the injector 14. The injection pressure of hydrogen of the injector 14 is determined by the set pressure of the pressure regulator 17.

### Regarding Deposit-Induced Pre-Ignition

In the following description, a surface of the piston 11 facing the combustion chamber 13 in the upper region in the figure is referred to as a piston crown surface 11A. A deposit derived from engine oil or the like may adhere to the piston crown surface 11A. In a case where the jet of hydrogen injected by the injector 14 hits the piston crown surface 11A, the deposit adhering to the piston crown surface 11A may become detached. In addition, the deposit piece detached from the piston crown surface 11A may remain in the cylinder 12 until the next injection and float in the combustion chamber 13. The deposit piece at this time is exposed to combustion and is at a high temperature. Therefore, the deposit piece floating in the combustion chamber 13 may be an ignition source and cause the generation of a pre-ignition. In a case where the jet of the hydrogen injected by the injector 14 does not hit the piston crown surface 11A, the deposit is not detached from the piston crown surface 11A. Therefore, the pre-ignition caused by the detached deposit from the piston crown surface 11A can be avoided by making the jet of hydrogen injected by the injector 14 not come into contact with the piston crown surface 11A.

### Regarding Relationship Between Dimension and Shape of Jet and Injection Specifications of Injector 14

Next, the relationship between the dimension and shape of the jet and the injection specifications of the injector 14 will be described with reference to FIG. 2. The jet here refers to a region in which hydrogen with a flow rate equal to or higher than a speed needed to detach the deposit from the piston crown surface 11A flows, in the cylinder 12. Further, here, for the sake of simplicity of description, it is assumed that the shape of the jet is a conical shape with the injection port 14A of the injector 14 as a vertex.

The dimension and shape of the jet in the cylinder 12 change depending on the injection pressure and the injection angle of the hydrogen from the injector 14, and the nozzle diameter of the injector 14. The larger the injection pressure, the longer the reach distance of the jet, and the smaller the spread angle of the jet. In addition, the larger the nozzle diameter, the longer the reach distance of the jet, and the smaller the spread angle of the jet. FIG. 2 shows a jet S1 with a long reach distance and a small spread angle, and a jet S2 with a short reach distance and a large spread angle.

In the following description, the position of the portion of the jet that is closest to the lower-region direction DW of the cylinder in the cylinder vertical direction is referred to as the bottommost position of the jet. In the case of FIG. 2, the bottommost position P1 of the jet S1 is located in the lower-region direction DW of the cylinder than the bottommost position P2 of the jet S2. In addition, the bottommost position of the jet also changes depending on the injection angle of the injector 14. Therefore, the bottommost position of the jet is determined by the specifications of the injector 14, such as the injection pressure, the injection angle, and the nozzle diameter. In addition, the timing (BTDC) when the piston crown surface 11A is located at the bottommost position of the jet is also determined by the specification of the injector 14.

Here, it is assumed that the shape and dimensions of the jet are maintained constant from just after the start of injection to the end of injection, and the jet disappears just after the end of injection. In this case, when the position of the piston crown surface 11A in the cylinder vertical direction at the injection end timing is located in the lower-region direction DW of the cylinder than the bottommost position of the jet, the jet does not come into contact with the piston crown surface 11A. The injection end timing of the injector 14 is determined by the injection timing, the injection quantity, the injection pressure, and the rotation speed of the engine 10. The injection timing here indicates timing at which the injector 14 starts to inject hydrogen. In addition, the start and end timings of the injection are represented by a crank angle (BTDC) of the engine 10. A time needed for injection of hydrogen by the injection quantity is obtained from the injection quantity and the injection pressure, and an amount of change in a crank angle during injection is obtained from the time and the rotation speed of the engine 10. The injection end timing can be calculated using the amount of change and the injection timing.

On the other hand, in the engine 10, the injection control of the injector 14 is performed by determining the injection timing and the injection quantity based on the driving condition of the engine 10 including the rotation speed. The design of the engine 10 for avoiding the contact of the jet with the piston crown surface 11A can be performed in the following aspects. First, the timing when the piston crown surface 11A is located at the bottommost position of the jet is obtained from the specification of the injector 14. Then, the value of the injection quantity and the injection timing for each driving condition is determined such that the injection end timing is always earlier than the obtained timing. In addition, in the following aspect, the engine 10 can be designed to avoid the contact of the jet with the piston crown surface 11A. First, the values of the injection quantity and the injection timing for each driving condition of the engine 10 are determined, and the latest injection end timing is obtained. Then, the injection pressure, the injection angle, and the nozzle diameter of the injector 14 are determined such that the bottommost position of the jet is located in the upper-region direction UP of the cylinder from the position of the piston crown surface 11A at the latest injection end timing.

The actual form of the jet is more complicated than that described here, but the form can be obtained by measurement, simulation, or the like. Then, the injection timing, the injection quantity, the injection pressure, the injection angle, and the nozzle diameter are set as in the above case according to the form of the obtained jet, whereby it is possible to design the engine 10 such that the jet does not come into contact with the piston crown surface 11A.

### Effect of Embodiment

The engine 10 of the present embodiment has the following effects.
(1) The engine 10 is configured as an in-cylinder injection hydrogen engine including an injector 14 injecting hydrogen into a cylinder 12. The injection timing, the injection quantity, the injection pressure, and the injection angle of hydrogen of the injector 14 of the engine 10, and the nozzle diameter of the injector 14 are set such that the jet of hydrogen injected by the injector 14 does not come into contact with the piston crown surface 11A. In the engine 10 set as described above, the detaching does not occur by the jet of the deposit adhering to the piston crown surface 11A. Therefore, the occurrence of pre-ignition by the deposits that have detached from the piston crown surface 11A is suppressed.
   (2) Hydrogen is gaseous fuel that has higher ignitability and is more likely to cause a pre-ignition than liquefied petroleum gas (LPG) or natural gas (CNG). Therefore, the effect of the above (1) is more remarkable than in the case of the engine using the other gaseous fuel.

### Other Embodiments

The engine 10 of the above-described embodiment may be configured to combust gaseous fuel other than hydrogen, such as LPG or CNG.

What is claimed is:

1. An engine comprising an injector configured to inject gaseous fuel into a cylinder,
wherein an injection timing, an injection quantity, an injection pressure, and an injection angle of the gaseous fuel by the injector and a nozzle diameter of the injector are set such that a jet of the gaseous fuel injected by the injector does not come into contact with a piston crown surface.

2. The engine according to claim 1, wherein the gaseous fuel is hydrogen.
